(19) United States
(12) Patent Application Publication
(10) Pub. No.: US 2023/0011589 A1
(43) Pub. Date: Jan. 12, 2023

(54) AIRCRAFT DOOR WITH A SAFETY LATCH COMPRISING AN ELECTROACTIVE POLYMER LINK

(71) Applicant: LATECOERE, Toulouse (FR)

(72) Inventors: Sebastien DEVILLEZ, SAINT JEAN (FR); Nicholas PRICE, Seattle, WA (US); Jingyang WU, Beijing (CN); Kenrick CHAN, Bellevue, WA (US); Bac TRAN, Chi Minth City (VN); Wilson MARTINEZ, Kent, WA (US)

(73) Assignee: LATECOERE, Toulouse (FR)

(21) Appl. No.: 17/757,499

(22) PCT Filed: Dec. 15, 2020
(86) PCT No.: PCT/EP2020/086180

§ 371 Date: Jun. 16, 2022

Related U.S. Application Data
(60) Provisional application No. 62/950,164, filed on Dec. 19, 2019.

(30) Foreign Application Priority Data
Dec. 19, 2019 (FR) FR1914934

(51) Int. Cl. E05B 81/04; B64C 1/14; E05B 81/18; E05B 81/50; E05B 81/56; E05B 81/74; E05B 77/04; E05B 77/54; E05B 83/42

(52) U.S. Cl. CPC E05B 81/04; B64C 1/1423; E05B 81/18; E05B 81/50; E05B 81/56; E05B 81/74; E05B 77/04; E05B 77/54; E05B 83/42; B64C 1/1461; B64D 25/08

(57) ABSTRACT

Aircraft door (1) including a safety latch (7) having a first locking element (8) and a complementary second locking element (9) which is movable; a link (11) having at least one electroactive polymer portion (13) and adapted to take up: a lock position in which the electroactive polymer portion (13) is supplied with power and the movable second locking element (9) is engaged with the first locking element (8); and an unlock position in which the electroactive polymer portion (13) is not supplied with power and the movable second locking element (9) is kept away from the first locking element (8); a control unit (16) having a power supply (26) for the electroactive polymer portion (13).

### CROSS REFERENCE TO RELATED APPLICATION

This application is a national stage entry of PCT/EP2020/086180 filed Dec. 15, 2020, under the International Convention and claiming priority over French Patent Application No. FR1914934 filed Dec. 19, 2019 and U.S. Provisional Application No. 62/950,164 filed Dec. 19, 2019.

### TECHNICAL FIELD

The invention relates to the field of aeronautics and concerns more particularly safety locking means for an aircraft door.

### PRIOR ART

Aircraft doors generally comprise a door frame and a leaf which is adapted to take up an open or closed position by virtue of an opening/closing mechanism which connects the leaf to the door frame. The opening/closing mechanism can be operated in various ways relating to normal use of the aircraft door or emergency opening of the door in the event of an emergency.

Under certain conditions, it is necessary to prevent an aircraft door from being opened, for safety reasons. Safety latches are thus generally provided to directly keep the leaf in its closed position, or to lock the opening/closing mechanism so that the door cannot be opened.

In aircraft fitted with such doors which can be locked by safety latches, it is however necessary to ensure that the door can indeed be opened, for example in the event of an emergency, and that the safety latches do not prevent such emergency opening.

### SUMMARY OF THE INVENTION

The invention aims to improve the aircraft doors found in the prior art.

To this end, the invention relates to an aircraft door comprising a frame and a leaf which is adapted to take up an open position in which the leaf is at a distance from the frame, and a closed position in which the leaf closes off the frame, this aircraft door comprising:

a safety latch comprising a first locking element and a complementary second locking element which is movable, the latch being adapted to lock the leaf in its closed position when the movable second locking element is engaged with the first locking element;

a link comprising at least one electroactive polymer portion, this link comprising a first end connected to an element of the door and a second end connected to the movable second locking element, this link being adapted to take up: a lock position in which the electroactive polymer portion is supplied with power and the movable second locking element is engaged with the first locking element; and an unlock position in which the electroactive polymer portion is not supplied with power and the movable second locking element is kept away from the first locking element;

a control unit comprising a power supply for the electroactive polymer portion, this control unit being adapted to supply power to the electroactive polymer portion and place the link in its lock position, when the aircraft speed exceeds a predetermined speed threshold.

As further subject matter, the invention relates to a method for the safety locking of an aircraft door as described above, comprising the following steps:

interrupting the power supply to the electroactive polymer portion and placing the link in its unlock position when the speed of the aircraft is below the predetermined speed threshold;

supplying power to the electroactive polymer portion and placing the link in its lock position when the speed of the aircraft exceeds the predetermined speed threshold.

Such an aircraft door guarantees that the safety latch will be applied, when necessary, reliably, using a device that is inexpensive, lightweight and consumes little electrical power. Electricity consumption is in fact reduced, since the link and more particularly the electroactive polymer portion requires little electrical power to keep the locking elements engaged.

The implementation of the safety latch requires few moving mechanical parts, a guarantee of reliability, since the locking elements engage purely as a result of the movement of the link caused by the behavior of the electroactive polymer portion. The risks of jamming and overheating are reduced.

The safety latch and the link may be used in the extreme temperatures required by aeronautical standards, for example from −40° C. to +70° C., or even −55° C. to +85° C.

The elements allowing the implementation of the safety latch are sufficiently compact to be easily integrated into an aircraft door mechanism.

The aircraft door according to the invention may comprise the following additional features, alone or in combination:

the electroactive polymer portion comprises an elastically deformable element which is elastically deformed when the link is in its lock position, and which is in the rest position when the link is in its unlock position, the link being urged into its rest position by the deformation of said elastically deformable element;

at least one electroactive polymer portion comprises a capacitive electroactive polymer having electrostrictive properties;

the capacitive electroactive polymer comprises a stack of a plurality of structures each comprising a layer of elastically deformable dielectric material sandwiched between two layers of conductive electrodes;

the control unit comprises a voltmeter adapted to measure the voltage present at the terminals of the electroactive polymer portion, and a correspondence table correlating the positions of the link with the voltage at the terminals of the electroactive polymer portion;

the control unit comprises a voltage converter adapted to supply the electroactive polymer portion with to a DC voltage of between 500 V and 5000 V;

the link has, in its lock position, a first bent position, and alternatively has, in its unlock position, a second bent position in which the electroactive polymer portion is deformed with respect to the first bent position;

the control unit is connected to a means for receiving information representative of the speed of the aircraft;

the control unit is adapted to interrupt the power supply to the electroactive polymer portion and place the link in its unlock position, in the event of an accident;

the control unit is connected to a means for receiving information relating to an aircraft accident.

The method according to the invention may comprise the following additional features, alone or in combination:

the method further comprises the step of interrupting the power supply to the electroactive polymer portion and placing the link in its unlock position, in the event of an accident;

the method further comprises the following step: when the aircraft speed is above the predetermined speed threshold and the aircraft altitude exceeds a predetermined altitude threshold, interrupting the power supply to the electroactive polymer portion and placing the link in its unlock position;

the method further comprises the following step: when the aircraft speed is above the predetermined speed threshold and the aircraft altitude returns to below the predetermined altitude threshold, supplying power to the electroactive polymer portion and placing the link in its lock position;

the method comprises a step of determining the position of the link by measuring the voltage at the terminals of the electroactive polymer portion.

### DESCRIPTION OF THE FIGURES

Further features and advantages of the invention will emerge from the non-limiting description which follows, with reference to the appended drawings in which:

FIG. 1 shows an aircraft door according to the invention;

FIG. 2 schematically depicts the safety latch of the door of FIG. 1, according to a first embodiment;

FIG. 3 is a perspective view of an electroactive polymer link of the device of FIG. 2;

FIG. 4 shows the electroactive polymer portion of the link of FIG. 3;

FIG. 5 shows part of the portion of FIG. 4, in a first position;

FIG. 6 shows the part of FIG. 5 in a second position;

FIG. 7 is a view similar to FIG. 2, in a second embodiment.

### DETAILED DESCRIPTION

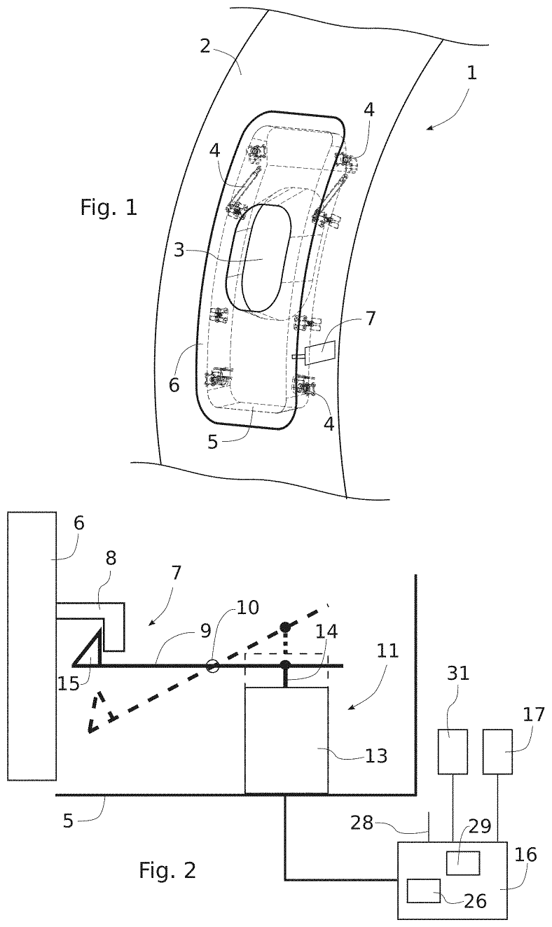

FIG. 1 schematically depicts an aircraft door 1 according to the invention. This door 1 is fitted in an aircraft of which part of the fuselage 2 is visible. The door 1 comprises, in addition to conventional equipment such as a window 3, an opening/closing mechanism 4 (visible in transparency in FIG. 1). Depending on the type of door, the opening/closing mechanism 4 may comprise hinges, opening arms and levers, handles, locking stops, etc. In this example, the door 1 is an emergency exit door. However, the door according to the invention may be used for all doors within the aircraft such as passenger doors, hold doors, etc., with the appropriate opening/closing mechanism.

The door 1 comprises a door frame 5 and a leaf 6 adapted to take up: a closed position (position visible in FIG. 1) in which the leaf 6 closes off the frame 5; and an open position in which the leaf 6 is at a distance from the frame 5 and allows the aircraft to be evacuated.

In addition to the opening/closing mechanism 4 which is adapted to lock the door 1 in its closed position, the door 1 also comprises a safety latch 7 for locking the leaf 6 in its closed position. Thus, when the latch 7 is active, it is impossible to open the door even when a user activates the means for unlocking and opening the door 1.

FIG. 2 schematically depicts the operation of the latch 7. In this schematic view, the leaf 6 is seen in profile and comprises a first locking element 8 which in this case consists of a striker integral with the door 1.

The latch 7 further comprises a second locking element 9 which in this case consists of a lever movable about an axis of rotation 10. At one of its ends, the second locking element 9 comprises a tooth 15 adapted to engage with the first locking element 8 to keep the door 1 in its closed position.

The aircraft door further comprises an electroactive polymer link 11 placed between the second locking element 9 and another element of the aircraft door such as, in the present example, the frame 5. Alternatively, the link 11 may be arranged between the second locking element 9 and any other element for keeping the leaf 6 in the closed position, for example a part of the opening/closing mechanism 4.

In the present example, the link 11 comprises an electroactive polymer portion 13 and a tie rod 14 connected to the portion 13. The tie rod 14 connects, for example by means of a ball joint, the link 11 to the second locking element 9.

The link 11 is adapted to take up two positions:

a lock position (shown in solid lines in FIG. 2) in which the link 11 positions the second locking element 9 such that its tooth 15 engages with the first locking element 8;

an unlock position (shown in dotted lines in FIG. 2) in which the link 11 positions the second locking element 9 such that its tooth 15 is away from the first locking element 8.

When the link 11 is in its lock position, the door 1 is in the safety-locked position and opening it is impossible. When the link 11 is in its unlock position, the door 1 operates normally and it can be opened when a user activates standard opening means or emergency opening means.

An electroactive polymer (EAP) is a polymer that changes shape or size when stimulated by an electric field. The electroactive polymer portion 13 comprises electrical connection terminals allowing it to be supplied with power and the generation of this electric field allowing this change of shape or size.

In the present example, the electroactive polymer portion 13 has electrostrictive properties. Thus, when this electroactive polymer portion 13 is supplied with power, its length decreases. The unlock position of the link 11 (shown in dotted lines in FIG. 2) therefore corresponds to a position of the link 11 in which the electroactive polymer portion 13 is not supplied with power and has a maximum length, while the lock position of the link 11 (shown in solid lines in FIG. 2) corresponds to a position of the link 11 in which the electroactive polymer portion 13 is supplied with power and has a minimum length.

The link 11 is electrically connected to a control unit 16 which is adapted to selectively supply power or interrupt the power supply to the electroactive polymer portion 13 of the link 11. The control unit 16 thus comprises a power supply adapted to the electroactive polymer constituting the portion 13, as well as electronic control means allowing power to be supplied according to parameters detected by the control unit 16. For example, the control unit 16 may be connected to the on-board network of the aircraft to collect information representative of the speed of the aircraft (schematized by the connection of the control unit 16 with a speed sensor 17 in FIG. 2). Furthermore, the control unit 16 may be connected to the on-board network of the aircraft to collect information representative of the altitude of the aircraft (schematized by the connection of the control unit 16 with an altitude sensor 31 in FIG. 2).

In the present example, the control unit 16 is configured to supply power to the electroactive polymer portion 13, and thus place the link 11 in its lock position, when the aircraft speed exceeds a predetermined speed threshold. When the aircraft speed is below this predetermined threshold, the control unit 16 interrupts the power supply to the electroactive polymer portion 13 so that the link 11 takes up its unlock position. According to this example, the aircraft door is not locked when the aircraft is on the ground and stopped, or taxiing at low speed on the runway (opening of the door is then possible for boarding and disembarking). Subsequently, when the aircraft accelerates and goes beyond the predetermined speed threshold, with a view to taking off, the door then benefits from safety locking effected by the latch 7 so as to prevent any possibility of the door opening when the aircraft is in motion and the altitude is not yet sufficient for the external pressure to be able to prevent the door from opening unexpectedly.

Conversely, when the aircraft speed returns below the predetermined speed threshold (for example when the aircraft slows down after having landed), the control unit 16 interrupts the power supply to the electroactive polymer portion 13 so that the link 11 takes up its unlock position and the door is ready to be opened when the aircraft comes to a stop.

Moreover, optionally, the control unit 16 may be configured to interrupt the power supply to the electroactive polymer portion 13, so that the link 11 takes up its unlock position, when the aircraft speed has exceeded the predetermined speed threshold and when the aircraft has also exceeded a predetermined altitude threshold. This situation corresponds to the case where, after taking off, the aircraft reaches an altitude (corresponding to the predetermined altitude threshold) above which the pressure difference between the inside and the outside of the aircraft exerts a strong force on the locking means of the door, and thus prevents the door from opening regardless of the safety latch. The latch is therefore superfluous in this situation, and can be deactivated.

According to this option, when, conversely, the aircraft returns below the predetermined altitude threshold, the safety latch is again activated by the action of the control unit 16 which supplies power to the electroactive polymer portion 13, and thus places the link 11 in its lock position. The latch will only be deactivated again when, after landing, the aircraft speed drops below the predetermined speed threshold as explained above.

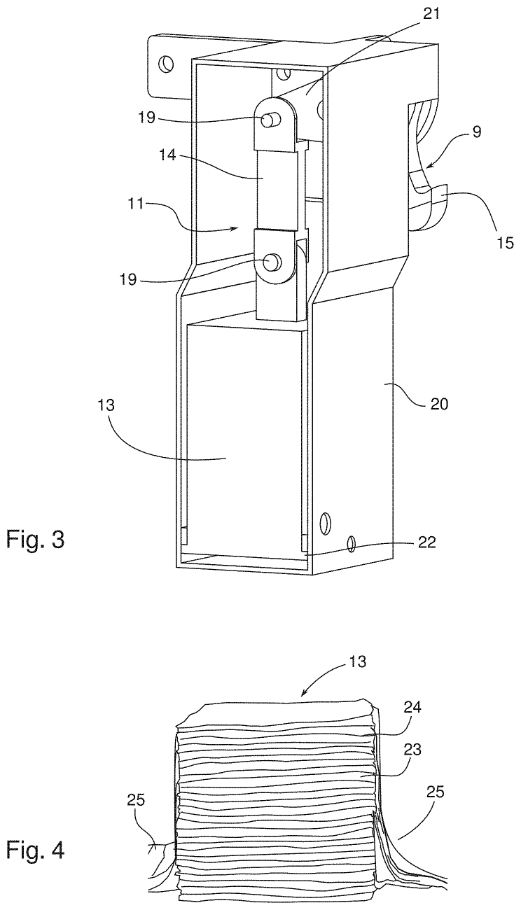

FIG. 3 is a perspective view of an embodiment of the assembly formed by the link 11 and the second locking element 9. According to this example, the link 11 comprises a parallelepiped electroactive polymer portion 13 and the tie rod 14 is provided with a pivot connection 19 at each of its ends. The link 11 is mounted in a surround 20 which is secured, for example, to the door frame 5. In FIG. 3, the link 11 is in its unlock position.

The second movable locking element 9 in this case consists of a bracket 21 provided at its end with the tooth 15 adapted to engage with the first locking element 8 (not shown in this FIG. 3). The second locking element 9 is pivotally mounted on the surround 20 and is connected to the link 11 by a pivot connection 19.

The link 11 comprises, at the electroactive polymer portion 13, a collar 22 for holding the link 11 in place relative to the surround 20 when the electroactive polymer portion 13 is supplied with power and the link 11 thus takes up its lock position.

In order for the link 11 to go into its lock position, the electroactive polymer portion 13 is supplied with power, which has the effect of reducing its height (according to the orientation visible in FIG. 3), so that the link 11 pulls on the second locking element 9, causing the bracket 21 to rotate and the tooth 15 to engage with the first locking element 8 (not shown in this FIG. 3).

FIG. 4 shows an embodiment of the electroactive polymer portion 13 of the link 11 of FIG. 3. According to this example, the electroactive polymer portion 13 consists of a capacitive electroactive polymer (capacitive electroactive polymers are also referred to as “dielectric electroactive polymers”). In this type of electroactive polymer, deformation is obtained by Coulomb forces. Capacitive electroactive polymers are materials in which the change in shape or size is caused by electrostatic forces between two electrodes which press a polymer which can be compressed in thickness.

The capacitive electroactive polymer portion 13 of FIG. 4 is in this case made up of an alternating stack of layers of an elastically deformable element, here a dielectric polymer 23, and layers of conductive electrodes 24. The layers of conductive electrodes 24 are connected to conductive mats 25 grouped in bundles and connected to the control unit 16 in order to supply power to the conductive electrodes 24.

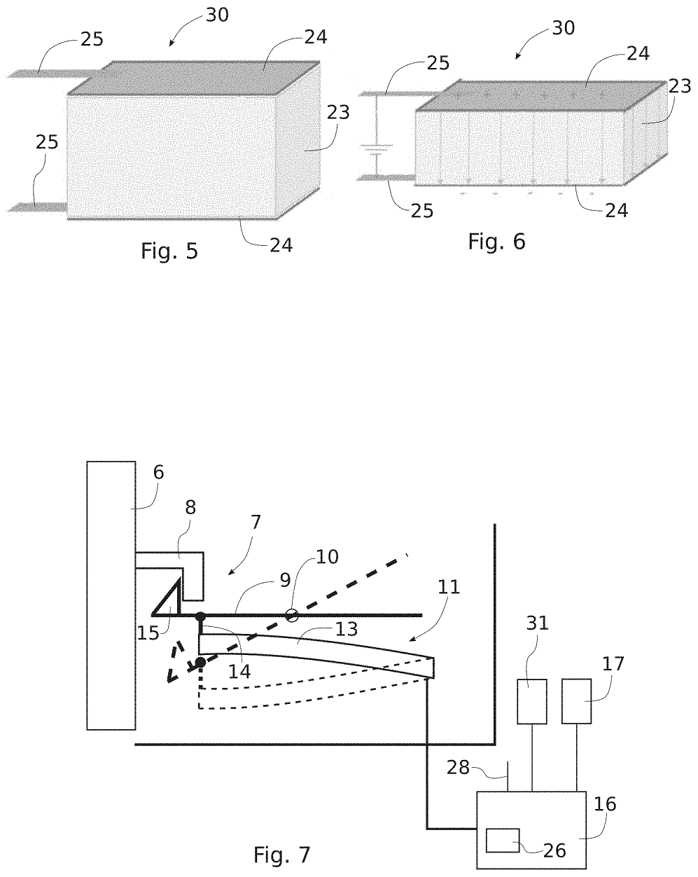

FIGS. 5 and 6 schematically show the structure and behavior of the stacks shown in FIG. 4. FIGS. 5 and 6 show an elementary structure 30 formed of a dielectric polymer 23 (for example an elastomer) held between two layers of conductive electrodes 24 which are each connected to a conductive mat 25. When power is not being supplied to the capacitive electroactive polymer, all the elementary structures 30 have the configuration shown in FIG. 5.

FIG. 6 shows the electroactive polymer of FIG. 5 when it is being supplied with power, i.e. when a DC voltage has been applied between the conductive mats 25. An electrostatic pressure occurs at the terminals of the electrodes 24 which thus move closer to one another, compressing the dielectric polymer 23. No current flows between the two electrodes 24 (apart from possibly a leakage current) while the latter are respectively positively and negatively charged. A reduction in the height of the assembly is thus obtained in the configuration of FIG. 6.

The electroactive polymer portion 13, which in this example is capacitive, consists of a stack of these elementary structures 30 and behaves as shown in FIGS. 5 and 6. A significant reduction in the height of the portion 13 is obtained when all the conductive polymer layers 24 are supplied with power in pairs, this reduction in height being calibrated (through the choice of the number of elementary structures 30, in particular) to move the second locking element 9 until tooth 15 engages.

When the electroactive polymer portion 13 is no longer being supplied with power, the elastic deformation energy which is contained in this portion 13 is used to move the link 11 into its unlock position and thus guarantee the unlocking of the device in the event of intentional interruption of the power supply to the portion 13 (following a command), or in the event of unintentional loss of electrical power, during an accident for example.

To this end, the electroactive polymer portion 13 has a rest position (when it is not being supplied with power) corresponding to its unlock position. Its lock position, when it is supplied with power, involves an elastic deformation of the electroactive polymer which stores enough energy to allow a return to the unlock position as soon as it is no longer being supplied with power, regardless of the reason for the interruption (intentional under the action of the control unit 16 or following an accident).

In this example, the capacitive electroactive polymer portion 13 is supplied with power at a high voltage, preferably from 0.5 to 5 kV, but has the advantage of almost zero power consumption. The control unit 16 comprises for this purpose a DC-DC converter 26 (or any other voltage conversion element) for converting the voltage available in an aircraft (generally 28 V DC) into a DC voltage in the range from 500 V to 5000 V, and constituting a power supply for the electroactive polymer portion.

In this first embodiment, the electroactive polymer portion 13 behaves like a variable capacitor, and the voltage at the terminals of the portion 13 is representative of the position (compressed or uncompressed) of the portion 13. The control unit 16 comprises a voltmeter 29 (or any other means of measuring or estimating voltage) making it possible to measure the voltage at the terminals of the portion 13, independently of the voltage delivered by the power supply 26. The voltmeter 29 will indicate a voltage measured at the terminals of the portion 13 for the link 11 in its lock position which will be different from the voltage for the link 11 in its unlock position. The control unit 16 can thus determine, from the voltage measured by the voltmeter 29, the position of the link 11 (locked or unlocked) by virtue, for example, of a correspondence table correlating the positions of the latch 7 with the voltage measured at the terminals of the electroactive polymer link 11. Operating reliability is thus improved for the aircraft door which thus has a measurement of the state of the link 11 without using a position sensor and without mechanical elements.

FIG. 7 shows a second embodiment of the invention, in which the second locking element 9 comprises an electroactive polymer portion 13 adapted to bend when supplied with power. FIG. 7 bears the same reference numerals for the elements in common with the first embodiment.

In FIG. 7, the lock position of the link 11 is shown in solid lines while its unlock position is shown in dotted lines. In this example, the link 11 comprises a bending rod consisting of an electroactive polymer portion 13, and a tie rod 14 for attachment to the second locking element 9. The electroactive polymer portion 13 for example in this case consists of an ionic electroactive polymer, which also constitutes an elastically deformable element. This type of electroactive polymer allows, in this configuration, the second locking element 9 to be placed in one or other of its positions shown respectively in solid and dotted lines in FIG. 7.

The control unit 16 is operated in the same way as in the first embodiment, by supplying or interrupting power to the portion 13. The link 11 is thus likewise adapted to take up two positions:

a lock position (shown in solid lines in FIG. 7) in which the link 11 positions the second locking element 9 such that its tooth 15 engages with the first locking element 8;

an unlock position (shown in dotted lines in FIG. 7) in which the link 11 positions the second locking element 9 such that its tooth 15 is away from the first locking element 8.

As the electroactive polymer portion 13 here consists of an ionic electroactive polymer, the converter 26 will in this case be a step-down converter, because this type of polymer generally requires a low voltage to be set in motion.

In the first embodiment and in the second embodiment, the control unit 16 may be implemented according to a method for safety locking of the aircraft door. This method comprises the following steps:

supplying power to the electroactive polymer portion 13 and placing the link 11 in its lock position when the speed of the aircraft is above the predetermined speed threshold;

interrupting the power supply to the electroactive polymer portion 13 and placing the link 11 in its unlock position when the speed of the aircraft is below the predetermined speed threshold.

Thus, when the aircraft is moving forward at low speed, on landing or take-off, and opening the door is theoretically possible, the latch 7 thus ensures safety locking of the door 1. However, if an accident occurs, then one or other of the following configurations comes into play:

the accident causes a power cut in the aircraft and the electroactive polymer portion 13 is no longer supplied with power, causing the link 11 to go into the unlock position, which then allows emergency opening of the door using the opening mechanism;

the accident does not cause a power cut in the aircraft and the control unit 16 will in this case interrupt the power supply to the electroactive polymer portion 13 so that, as before, the link 11 goes into its unlock position and emergency opening is permitted. In this case, the control unit 16 is advantageously provided with a connection 28 to sensors, to the on-board network of the aircraft, or to any other means allowing the control unit 16 to obtain information indicating the occurrence of an accident.

Alternative embodiments of the aircraft door and its method of implementation may be provided without departing from the scope of the invention. In particular, the safety latch may be arranged just as easily between the door frame and the leaf as within the opening/closing mechanism itself, in any position allowing locking of the leaf of the door.

Furthermore, the link 11 may comprise a single electroactive polymer portion 13 or several electroactive polymer portions.

1. An aircraft door (1) comprising
a frame (5);
a leaf (6) adapted to take up an open position in which the leaf (6) is at a distance from the frame (5), and a closed position in which the leaf (6) closes off the frame (5);
a safety latch (7) comprising a first locking element (8) and a complementary second locking element (9) which is movable, the latch (7) being adapted to lock the leaf (6) in its closed position when the movable second locking element (9) is engaged with the first locking element (8);
a link (11) comprising at least one electroactive polymer portion (13), link (11) comprising a first end connected to an element of the door and a second end connected to the movable second locking element (9), the link (11) being adapted to take up: a lock position in which the electroactive polymer portion (13) is supplied with power and the movable second locking element (9) is engaged with the first locking element (8); and an unlock position in which the electroactive polymer portion (13) is not supplied with power and the movable second locking element (9) is kept away from the first locking element (8);
a control unit (16) comprising a power supply (26) for the electroactive polymer portion (13), the control unit (16) being adapted to supply power to the electroactive polymer portion (13) and place the link (11) in its lock position, when the aircraft speed exceeds a predetermined speed threshold.

2. The aircraft door as claimed in claim 1, wherein the electroactive polymer portion (13) comprises an elastically deformable element which is elastically deformed when the link (11) is in its lock position, and which is in the rest position when the link (11) is in its unlock position, the link (11) being urged into its rest position by the deformation of said elastically deformable element.

3. The aircraft door as claimed in claim 2, wherein at least one electroactive polymer portion (13) comprises a capacitive electroactive polymer having electrostrictive properties.

4. The aircraft door as claimed in claim 3, wherein the capacitive electroactive polymer comprises a stack of a plurality of structures (30) each comprising a layer of elastically deformable dielectric material (23) sandwiched between two layers of conductive electrodes (24).

5. The aircraft door as claimed in claim 3, wherein the control unit (16) comprises a voltmeter (29) adapted to measure the voltage present at the terminals of the electroactive polymer portion (13), and a correspondence table correlating the positions of the link (11) with the voltage at the terminals of the electroactive polymer portion.

6. The aircraft door as claimed in claim 1, wherein the control unit (16) comprises a voltage converter (26) adapted to supply the electroactive polymer portion (13) with to a DC voltage of between 500 V and 5000 V.

7. The aircraft door as claimed in claim 2, wherein the link (11) has, in its lock position, a first bent position, and alternatively has, in its unlock position, a second bent position in which the electroactive polymer portion (13) is deformed with respect to the first bent position.

8. The aircraft door as claimed in claim 1, wherein the control unit (16) is connected to a device (17) for receiving information representative of the speed of the aircraft.

9. The aircraft door as claimed in claim 1, wherein the control unit (16) is adapted to interrupt the power supply to the electroactive polymer portion (13) and place the link (11) in its unlock position, in the event of an accident.

10. The aircraft door as claimed in claim 1, wherein the control unit (16) is connected to a device (28) for receiving information relating to an aircraft accident.

11. A method for the safety locking of an aircraft door (1) as claimed in claim 1, the method being comprising the following steps:
interrupting the power supply to the electroactive polymer portion (13) and placing the link (11) in its unlock position when the speed of the aircraft is below predetermined speed threshold;
supplying power to the electroactive polymer portion (13) and placing the link (11) in its lock position when the speed of the aircraft exceeds the predetermined speed threshold.

12. The method as claimed in claim 11, further comprising the step of interrupting the power supply to the electroactive polymer portion (13) and placing the link (11) in its unlock position, in the event of an accident.

13. The method as claimed claim 11, further comprising the following step:
when the aircraft speed is above the predetermined speed threshold and the aircraft altitude exceeds a predetermined altitude threshold, interrupting the power supply to the electroactive polymer portion (13) and placing the link (11) in its unlock position.

14. The method as claimed in claim 13, further comprising the following step:
when the aircraft speed is above the predetermined speed threshold and the aircraft altitude returns to below the predetermined altitude threshold, supplying power to the electroactive polymer portion (13) and placing the link (11) in its lock position.

15. The method as claimed in claim 11 for safety locking of an aircraft door as claimed in claim 5, comprising a step of determining the position of the link (11) by measuring the voltage at the terminals of the electroactive polymer portion (13).
